(19) United States
(12) Patent Application Publication
(10) Pub. No.: US 2023/0366749 A1
(43) Pub. Date: Nov. 16, 2023

(54) DEVICES, SYSTEMS AND METHODS FOR DETERMINING A CORE TEMPERATURE ESTIMATE

(71) Applicant: EPYMETRICS AG, Zürich (CH)

(72) Inventors: Yves Delley, Zürich (CH); Peter Seitz, Zürich (CH)

(21) Appl. No.: 18/043,911

(22) PCT Filed: Sep. 5, 2021
(86) PCT No.: PCT/IB2021/058087

§ 371 Date: Mar. 3, 2023

(30) Foreign Application Priority Data
Sep. 4, 2020 (CH) 01092/20

(51) Int. Cl. G01K 7/42; G01K 7/16; G01K 1/02; G01K 1/143

(52) U.S. Cl. CPC G01K 7/427; G01K 7/16; G01K 1/026; G01K 1/143

(57) ABSTRACT

Embodiments pertain to a core temperature measurement device for determining an object's core temperature, comprising: at least three sensor modules, each sensor module configured as a thermal resistor, wherein a sensor module comprises: a surface thermometer contact configured to produce a surface temperature signal relating to a sensed surface temperature; and an ambient thermometer contact configured to produce an ambient temperature signal relating to a sensed ambient temperature; wherein the surface thermometer contact and the ambient thermometer contact are thermally insulated from each other, a memory configured to store software code instructions; and a processor configured to execute software instructions stored in the memory to perform the following, when the at least three sensor modules are operably engaged with a surface portion of an object to cause elastic deformation of the surface region: determining a core temperature of a region below the surface region of the object.

### CROSS-REFERENCE TO RELATED APPLICATIONS

This patent application is a 371 from international patent application PCT/IB2021/058087, filed Sep. 5, 2021, which claims priority and benefit from CH patent application 01092/20, filed Sep. 4, 2020, and which is incorporated herein by reference in its entirety.

### BACKGROUND

One of the most important thermodynamic measurement tasks is the determination of the key physical parameter temperature. This measurement is effectuated with a thermometer, capable of measuring temperature at the location where the thermometer is placed. In this way, the surface temperature of an object can be determined.

However, in many cases the inner or core temperature of the object is of interest. A preferred device and method for accomplishing this is illustrated in FIG. 1 and taught for example by D. Lees et al. in “Noninvasive Determination of Core Temperature During Anesthesia”, Southern Medical Journal Vol. 73, No. 10, October 1980.

The fundamental device consists of a piece of material 7, here forth called “thermal resistor”, with the precisely known thermal resistance value R, placed on the object's surface, which separates object 1 from its ambient thermal environment 2. On both ends of thermal resistor 7 a thermometer is placed. Thermometer 6 measures the surface temperature TS, and thermometer 8 measures the ambient temperature TA.

According to the fundamental thermodynamic laws of thermal energy transport, a temperature difference ΔT between the two sides of a thermal resistance R causes the transport of the heat energy E during the time t, given by

E=ΔT×t/R (1)

R denotes the thermal resistance of the devices' thermal resistor 7, S denotes the resistance of the object's thermal resistance/insulation 4 between the object core and the object surface, and reference “U” denotes the thermal resistance of the material in the contact or engagement zone 5 between the device and the object's surface, henceforth called “(thermal) contact resistance”. Merely to simplify the discussion that follows, both the device and the object surface are considered and schematically illustrated as having a cylindrical geometry.

For an extended and substantially isotropic object 1, flow of heat energy can be considered to be perpendicular to the object's surface. Because of the conservation of energy, any heat 9 flowing out of the objects core located at 3 will flow through the object's interface 4, will further exit the object and enter the device through the contact zone 5. The amount of heat energy transferred this way will be related to the temperature difference between the core and the surface through

E=(T_{S}−T_{C})×t/(S+U) (2)

Because of the conservation of energy, the heat energy entering the device at 6 will exit the device at 8 as heat energy 10 provided that no or only negligible amount of thermal energy is laterally dissipated from the device. This can be achieved through suitable device design such that it can be assumed that all or substantially all thermal energy flowing through thermal contact 6 reaches thermal contact 8. For example, thermal insulation of the device may be configured to reduce or prevent energy dissipation between thermal sensing contacts 6 and 8. In a further example, a ratio between the surface areas of the thermal sensing contacts and a distance between the contacts of the same sensor module is comparatively large, such that transfer of thermal energy not flowing through the contacts can be neglected.

The heat energy 10, given by

E=(T_{S}−T_{A})×t/R (3)

entering the device at the object's surface 6 is identical with energy leaving the object. Therefore, the following fundamental equation holds:

T_{C}−T_{A})×R=(T_{S}−T_{A})×(S+U+R) (4)

The temperatures T_{A} and T_{S} are measured by thermometers 6 and 8. The resistance R of thermal resistor 7 is known. When assumptions about the values of the inner thermal resistance S and the contact thermal resistance U are made, it is possible to calculate the core temperature T_{C} based on the above equation. However, in practice it is very difficult to keep the contact resistance U stable because it varies with the pressure with which the measurement device is put into contact with the object's surface. For this reason, many of today's core temperature measurement devices suffer from ignoring the exact value of the thermal contact resistance U.

A method to overcome this limitation is taught by D. Lees et al. in the above-mentioned publication. It is based on a heating element placed above thermometer 8, feeding heat energy 11 into thermal resistor 7. When external heat energy 11 is exactly balancing core heat 9 and 10, no net heat energy is transported into or out of the device. Consequently, all three temperatures T_{C}, T_{S} and T_{A} are identical, and by measuring T_{S}, the sought T_{C} is also determined.

### BRIEF DESCRIPTION OF THE FIGURES

The invention will be better understood and objects other than those set forth above will become apparent when consideration is given to the following detailed description thereof. Such description makes reference to the annexed drawings, wherein:

FIG. 1 illustrates the state-of-the-art in core temperature measurement, utilizing a device that is placed on the surface of the object's surface whose core temperature needs to be determined.

FIGS. 2A, 2B and 2C schematically illustrate a device for sensing core temperature, according to some embodiments.

FIG. 3 is a schematic diagram of the network of thermal resistances, as employed for the measurement of an object's core temperature, according to some embodiments.

FIG. 4 is a schematic diagram of a mechanical model in which the device's substrate plane is inclined with respect to the object's surface.

FIG. 5 schematically illustrate a device for sensing core temperature, according to an alternative embodiment.

FIG. 6 schematically illustrates a system for sensing core temperature, according to an embodiment.

FIG. 7 is a flowchart of a method for determining core temperature, according to an embodiment.

### DETAILED DESCRIPTION

The heat-balancing method described in Lees requires a heating element, dissipating electrical energy. This is not desirable in a portable or wearable core-temperature measuring system where low-energy performance is a central requirement.

Consequently, today's devices, systems and methods for determining the core temperature of an object require a compromise:

One basic approach requires additional electrical energy for the heating element which balances the transport of heat energy. Alternate approaches do not employ a heating element, but this results in imprecise measurements because it is practically very difficult to keep the thermal contact resistance constant and to know its precise value.

In some examples, it may thus be an objective to provide a device and a method for determining an object's core temperature, without requiring a heat-balancing heating element consuming electrical energy.

In some examples, it may be the objective to provide a device and a method for determining the core temperature of an object by requiring only the sensing (e.g., measurement) of temperatures using conventional miniaturized thermometers.

It some examples, it may be the objective to provide a device and a method with which the inner thermal conductance (also called bulk thermal conductance) of an object can be measured.

Aspects of embodiments pertain to devices and methods with which an object's core temperature can be determined.

In some embodiments, the expression “determining a core temperature” or “measuring a core temperature” of an object, as well as grammatical variations thereof, may also encompass the meaning of the term “determining a core temperature estimate”. The core temperature may pertain to or be a temperature estimate at some “CT depth” below the object surface. The CT depth may correspond to a depth or depth range below the object's surface at which the object has or is assumed to have comparatively high thermal conductance, compared to a thermal conductance above the CT depth (range).

For example, when engaging the device with the skin of a mammalian (e.g., human skin), the derived or estimated CT may be considered to be the temperature of an underlying “highly perfused layer” having comparatively higher blood perfusion than that the layer extending from the skin's outer surface to the said “highly perfused layer”. Accordingly, embodiments may relate to determining a core temperature of circulating blood and/or a tissue region underlying a tissue surface.

Although embodiments may relate to determining a core temperature of circulating blood and/or a tissue region underlying a tissue surface, this should by no means be construed in a limiting manner. Hence, embodiments disclosed herein may also pertain to determining or measuring core temperature of non-living objects such as, for example, edibles with temperature requirements for storage or consumption, and/or the contents of sealed receptacles (e.g., tubes or containers) storing (e.g., potentially hazardous or toxic) chemical or biological materials.

In examples where the object is known to have or can be assumed to have comparatively uniform or isotropic thermal characteristics, independent of the depth below the surface, the CT may for instance be considered to be determined for a depth that corresponds to a distance between neighboring thermal resistors. For example, the CT may be for a depth below the surface, at a factor of 1, 1.25, 1.5 or 2 of the (e.g., average or median) distance between two neighboring thermal resistors.

In some embodiments, to overcome at least some of the limitations of today's core temperature sensing devices and methods, a device is provided configured for sensing, measuring and/or determining the core temperature of an object. The device may comprise at least three more sensor modules.

Aspects of embodiments also relate to a method for determining of the inner thermal resistance of an object, between the inner position where the core temperature is observed and the object's surface.

The sensor modules may for example be arranged either in rectilinear or in a suitable two-dimensional fashion on a rigid substrate.

Each sensor module may include two thermometers, placed at either end of a thermal resistor with known thermal resistance. One end of each sensor module is in thermal contact with the surface of the object, the other end is in thermal contact with the ambient environment.

A multi-parameter model relating the surface contact resistance of each sensor module to its geometric position on the rigid substrate is employed to generate a set of linear equations relating the various unknowns (i.e., the core temperature, the surface contact thermal resistances, as well as the object's bulk thermal resistance) to the measured temperature values.

These equations are based on the physical law of thermal energy conversation in a closed system. Provided that the number of parameters in the multi-parameter model is smaller than the number of sensor modules minus one, the set of linear equations can be employed to calculate optimum values of all unknowns, in particular the core temperature, the surface contact thermal resistances, as well as the object's bulk thermal resistance.

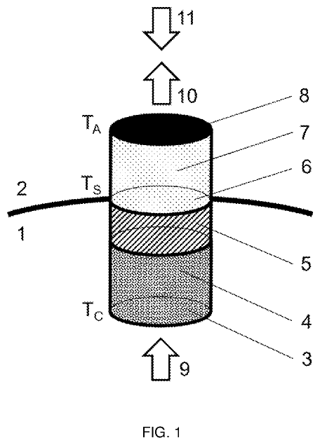

It is noted that for a sensor module according to embodiments, the same assumptions are made as outlined with respect with respect to the device shown in FIG. 1 to arrive at the equation describing the transferred heat energy:

For example, thermal insulation of a sensor module according to an embodiment may be configured to reduce or prevent energy dissipation between thermal sensing contacts. In a further example, a ratio between the surface areas of the thermal sensing contacts and a distance between the contacts of the same sensor module is comparatively large, such that transfer of thermal energy not flowing through the contacts can be neglected.

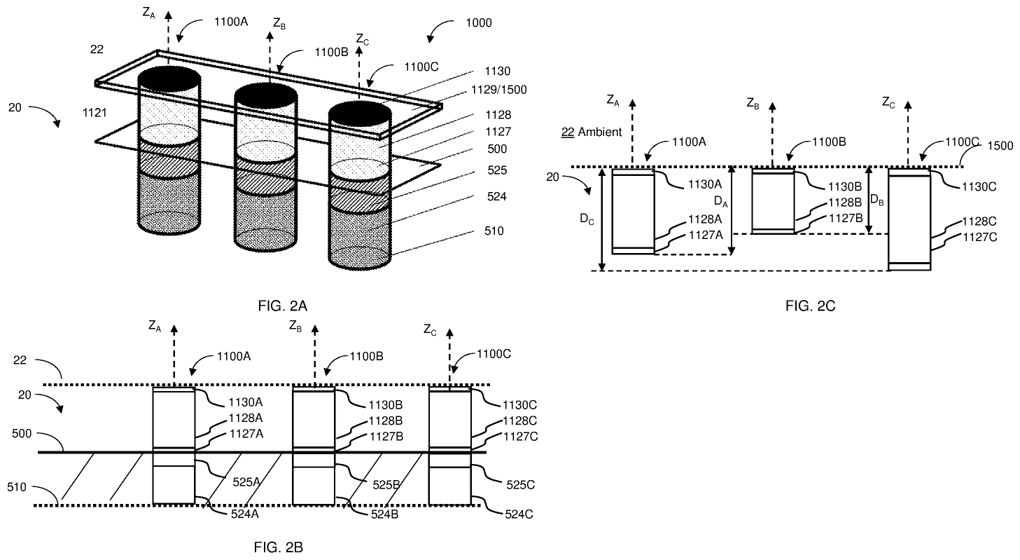

Reference is now made to FIGS. 2A and 2B. With the foregoing objectives in view, a device 1000 for use in determining a core temperature (CT) comprises a plurality of sensors 1100 (e.g., first sensor module 1100A, second sensor module 1100B and third sensor module 1100C). Each sensor 1100 may comprise a thermal resistor 1128 having a known thermal resistance value Rᵢ, and further comprise surface thermometers 1127 having a surface contact side, and ambient thermometers 1130 having an ambient side, at either end of the thermal resistor, as schematically illustrated in FIGS. 2A and 2B. A thermal resistor 1128 may thus be sandwiched between each surface thermometer 1127 and ambient thermometer 1130.

Surface thermometers 1127 are configured to measure the individual surface temperatures Tᵢ for each of the i=1 . . . N sensor modules 1100 on surface 500 of the object, and ambient thermometers 1130 are configured for sensing the ambient temperature T_{A} of ambient environment 22.

In an embodiment, a thermal conductor 1129 may be employed and be operably coupled with ambient thermometers 1130 to ensure that all ambient temperature values measured by individual ambient thermometers 1130 are the same or substantially the same. In this embodiment, all but one ambient thermometer 1130 may be omitted. In some examples, thermal conductor 1129 may function as ambient thermometer 1130, and thermal conductor 1129 may be identical to ambient thermometer 1130.

In some embodiments, sensor modules may each have a corresponding longitudinal axis Z (e.g., Z_{A}, Z_{B} and Z_{C}). The longitudinal axes Z may be parallel or substantially parallel relative to each other and be normal to a common (e.g., virtual) plane 1500. In some embodiments, the common virtual plane 1500 may be defined by a rigid substrate, which may include and/or function as common thermal conductor 1129, e.g., as exemplified in FIG. 2A and further outlined herein.

In some embodiments, the surface contact sides of sensor modules 1100 may be coplanar, i.e., arranged at a same first distance from common virtual plane 1500, and the ambient sides of sensor modules 1100 may be coplanar, i.e., arranged at a same second distance from common virtual plane 1500, different from the first distance, e.g., as shown schematically in FIG. 2B.

In some embodiments, at least two or all of the surface contact sides of sensor modules 1100 may be non-coplanar, and the ambient sides may be coplanar.

In some embodiments, at least two or all of the surface contact sides may be coplanar, and at least two or all the ambient sides may be non-coplanar.

In some embodiments, at least two or all of the surface contact sides may be non-coplanar, and at least two or all of the ambient sides may be non-coplanar.

FIG. 2C exemplifies an embodiment in which three contact sides D_{A}, D_{B} and D_{C} have different distances relative to plane 1500 (D_{B}<D_{A}<D_{C}) and in which the ambient sides are coplanar.

In any case, the operational parameter values of the sensor modules are known such that a solvable or overdetermined set of equations for the contact resistances can be constructed. In some examples, the vertical distances between neighboring contact surface sides and/or ambient sides may be chosen to facilitate creating such set of equations, e.g., to facilitate modelling a linear a non-linear relationship between thermal contact resistances when operably engaging the surface sides with the object surface.

Sensor modules 1100 may be mounted on a rigid substrate, so that each thermometer 1127 is in stable thermal contact with surface 500 of object 20 to measure, for example, for an underlying inner tissue region 510, a core temperature T_{C}. Individual thermal resistors 1128 are thermally insulated from each other in interior 1121 of CT sensing device 1000.

An inner object core region 510 may be inaccessibly located under the surface of object material 524. The expression “inaccessibly located” pertains to a situation where direct access can only be gained in destructive manner. Hence, in some embodiments, embodiments pertain to a device and apparatus that allows non-destructive determination of an object's core-body temperature.

The thermal contact resistance between the surfaces of device 1000 and object 20 depend on the contact force due to elastic deformation of the contact region 525. In some examples, an inner tissue region 510 is located under a tissue surface.

In some examples, the core temperature T_{C} may be considered to be the temperature measured at a geometric center of a tissue region, underlying the tissue surface. In some examples, the geometric center may coincide with the center of gravity of the tissue region, for example, when assuming homogenous distribution of the tissue's specific weight in the tissue region. For approximation purposes, all points of the core object region 510 may be considered to have the same core temperature T_{C}.

In some examples, the core temperature T_{C} may be considered the temperature of a fluid (e.g., gas, and/or liquid) flowing inside the object. In some examples the fluid may be blood perfusing a tissue region.

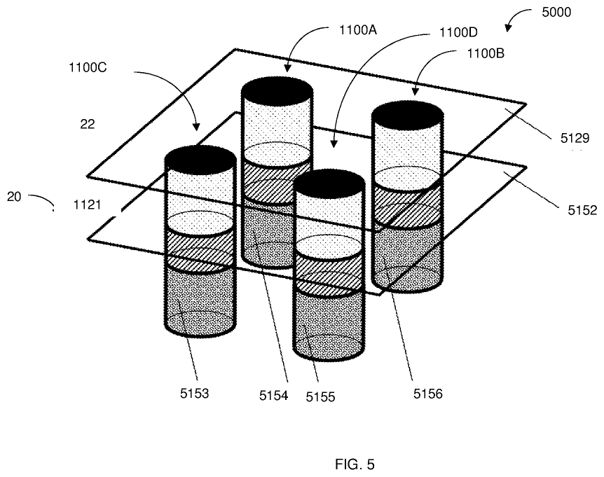

The N sensor modules 1100 may be arranged either in rectilinear fashion, as schematically illustrated in FIG. 2 for the case of N=3 sensor modules, in two-dimensional fashion, e.g., as schematically illustrated in FIG. 5 for the case of N=4 sensor modules 1100A-1100D, or any other suitable two-dimensional, e.g., rectilinear matrix sensor module arrangement or non-rectilinear sensor module arrangement.

In any case, the conservation of thermal energy leads to the same equation relating the measured temperatures for each of the N sensor modules, as introduced above:

(T_{C}−T_{A})×Rᵢ=(Tᵢ−T_{A})×(S+Uᵢ+Rᵢ) (5)

with the individual surface temperatures Tᵢ measured by thermometers 1127 by each one of sensor modules 1100.

Thermal contact resistance of the contact region 525 (e.g., regions 525A-C) of resistance value Uᵢ with which each sensor module 1100 thermally connects to object 20 at surface 500, is in turn thermally connected to object core region 510 via object material 524 (e.g., respective object material 524A-C) having thermal resistance S.

Exemplarily, any such region 524 thermally connecting the object's core 510 with the object surface 500 may be schematically represented as a resistor having resistance S, which may henceforth also be referred to as “object insulation resistance”.

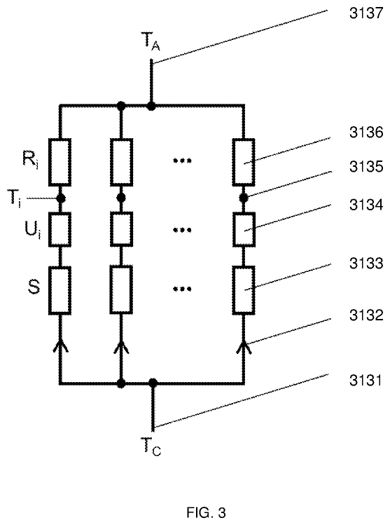

Further reference is now made to FIG. 3, which shows a schematic diagram (thermal circuit) of the transport of heat energy for device 1000 thermally coupled with object 20, as described by the equation

(T_{C}−T_{A})×Rᵢ=(Tᵢ−T_{A})×(S+Uᵢ+Rᵢ) (6)

In interior 3131 of object 20, the core temperature T_{C} is present. Heat energy 3132 is transported through the various branches of each sensor module:

Heat energy 3132 transfers through object insulation resistance 3133 and through individual contact resistance 3134, before entering individual resistance 3136 of each sensor module 1100 through thermal contact point 3135 and leaving the device 1000 into the ambient environment 3137, where the temperature T_{A} is present.

Obviously, the above system of N equations is underdetermined because we have N+2 unknown variables, namely contact resistance values Uᵢ (i=1 . . . N), the object thermal insulation resistance values S, and the sought core temperature T_{C}.

For three sensor modules, we would arrive at five unknowns, namely U₁, U₂, U₃, S and T_{C}.

All other parameters are either known by design, i.e., the device's resistance values Rᵢ (i=1 . . . N), or they are measured temperatures, i.e., Tᵢ (i=1 . . . N) and T_{A}.

In some embodiments, this underdetermined situation may be resolved by the following method:

It is an empirical fact that by increasing the contact force, with which two objects are pressed against each other, one is reducing the thermal resistance between the two objects. Since this functional relationship is monotonous and smooth, it can be linearized or otherwise mathematically modelled for a small change ΔF in the force between the two objects, leading to a corresponding small change ΔU in the thermal resistance U, according to the following approximate relationship:

ΔU=−k×ΔF (7)

with a material- and pressure-dependent proportionality constant k, and the minus sign is due to the reduction of thermal resistance if the force is increased.

This approximate relationship holds for all contact thermal resistances Uᵢ (i=1 . . . N) of the sensor modules of a CT sensing device, because basic sensor modules are placed so close to each other that their individual contact pressure is of comparable value, so that the above linearization holds true.

The CT sensing device, when operably engaged with the surface of object 20 placed on the surface of object 20, allows determining the core temperature T_{C} by a system employing the sensing device.

It is noted that it cannot be guaranteed that virtual plane defined by the device's thermometers 1127 is perfectly parallel to the surface 500 of object 20. Consequently, an angle may possibly be formed between the sensor plane of the CT sensing device and the surface plane of the object. Such angle leads to different forces and different thermal resistances of the various sensor modules.

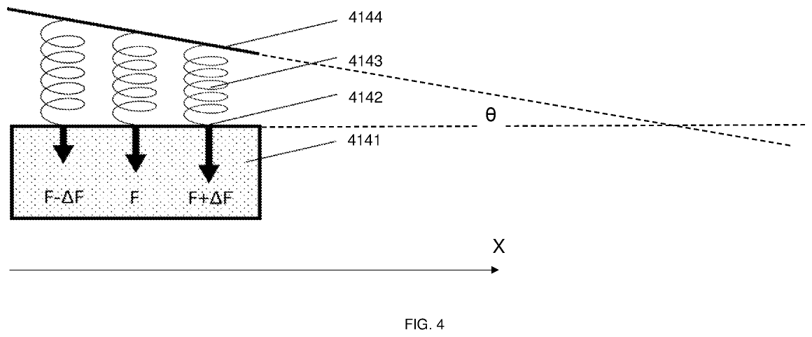

This situation is schematically illustrated in FIG. 4 for an object 4141 whose surface plane 4142 forms an angle θ relative to sensor plane 4144.

Many objects show some elastic deformation as a function of applied force, assuming that the force does not exceed the elastic range.

Assuming that the mechanical deformation of the object's surface is elastic, a corresponding force-dependent thermal contact resistance may for example modeled as a linear function of the deformation. It some examples it is assumed that the object's surface remains planar, e.g., before and after the applied pressure causing the deformation.

This scenario schematically illustrated in FIG. 4 with mechanical springs 4143. As a consequence, the contact force Fᵢ (i=1 . . . N) is increasing linearly as a function of increased lateral distance D along axis X. With the precise knowledge of the lateral position of each sensor module it is thus possible to calculate the differential thermal contact resistance of each sensor module according to the equation shown above.

As an example of this method, consider the rectilinear device with N=3 schematically illustrated in FIGS. 2A and 2B, where the distance between the three sensor modules 1100A, 1100B and 1100C is selected to be the same. In this case, the total thermal resistances Zᵢ (i=1 . . . 3) from the object's core region to ambient thermometers 1130, schematically illustrated by the object's thermal resistances 524 and 525, are the following for the three sensor modules 1100A-C:

Z₁=S−V (8)

Z₂=S (9)

Z₃=S+V (10)

and the energy conservation equations introduced above lead to the following three linear equations:

(T_{C}−T_{A})×R₁=(T₁−T_{A})×(S−V+R₁) (11)

(T_{C}−T_{A})×R₂=(T₂−T_{A})×(S+R₂) (12)

(T_{C}−T_{A})×R₃=(T₃−T_{A})×(S+V+R₃) (13)

In this way, we obtain a set of three linear equations that can be solved for the three unknowns T_{C}, S, V, where we know the three thermal resistances R₁, R₂ and R₃, and where we can measure the four temperatures T_{A}, T₁, T₂ and T₃.

It is noted that the choice of R₁, R₂ and R₃ affects the accuracy of the solved unknowns, and that in particular they cannot be all equal for the equations to be linearly independent and thus the set be solvable.

In case more sensor modules are employed than the minimum number N=3, one has two possibilities:

(1) A more elaborate geometrical model of the contact between the object surface and the sensor plane is employed, while still making use of the linear relationship between contact force and contact thermal resistance.

In any case, the number of model parameters cannot exceed N−2, so that the set of linear equations does not become underdetermined.

2) The resulting set of N linear equations is overdetermined, and the sought three parameters T_{C}, S, V can be determined by one of the known optimization methods, for example least-squares minimization.

This method according to embodiments can also be extended to two-dimensional arrangements of sensor modules, as schematically illustrated in FIG. 5 for the case N=4 with respect to CT sensing device 5000.

As an example, a 2×2 square array of sensor modules 1100A-D, operably engaged with object surface 5152, in four heat energy transport paths 5153, 5154, 5155 and 5156 is shown. As described above, the thermal contact resistances Zᵢ (i=1 . . . 4) can be approximated by the following four equations:

Z₁=S−V (14)

Z₂=S+V (15)

Z₃=S−W (16)

Z₄=S+W (17)

The reason for the two unknown parameters V and W lies in the fact that the inclination of the surface plane with respect to the sensor plane may not be the same for the two orthogonal directions.

As described above, this leads to the following four linear equations:

(T_{C}−T_{A})×R₁=(T₁−T_{A})×(S−V+R₁) (18)

(T_{C}−T_{A})×R₂=(T₂−T_{A})×(S+V+R₂) (19)

(T_{C}−T_{A})×R₃=(T₃−T_{A})×(S−W+R₃) (20)

(T_{C}−T_{A})×R₄=(T₄−T_{A})×(S+W+R₄) (21)

In this way, we obtain a set of four linear equations of the four unknowns T_{C}, S, V, W, where we know the four thermal resistances R₁, R₂, R₃ and R₄, and where we can measure the five temperatures T_{A}, T₁, T₂, T₃ and T₄.

In an embodiment, a thermal conductor 5129 may be employed and be operably coupled with ambient thermometers 1130 to ensure that all ambient temperature values measured by individual ambient thermometers 1130 of sensor modules 1100A-D are the same or substantially the same. In this embodiment, all but one of the ambient thermometers 1130 may be omitted.

Another embodiment of the device makes use of the relationship between the heat energy E flowing through an area A during time t:

The thermal flux Φ is defined as

Φ=E/(A×t) (22)

Consequently, it is possible to replace one or several of the sensor modules in FIGS. 1, 2 and 5 by so-called thermal flux sensors, capable of measuring thermal flux Φ and the surface temperature T_{S}. It is therefore possible to re-formulate the heat energy conservation law mentioned above by a thermal heat flux conservation law.

This results in a different set of linear equations for the unknowns T_{C}, S, V, W, where the measured parameters are surface temperatures Tᵢ and heat flux values Φᵢ. All other aspects of the device and method remain the same.

According to some embodiments, the method can also be employed for the determination of core temperature T_{C} simultaneously with the thermal resistance values Zᵢ in more complex situations where the total internal thermal resistance values Zᵢ are not given by the simple linear relationship Zᵢ=B+C xᵢ, as described above, for a linear array of thermometers.

Considering for example a one-dimensional case with a quadratic relationship between total internal thermal resistance Zᵢ and sensing position xᵢ, i.e., Zᵢ=B+C xᵢ+D xᵢ². In this case, four unknowns must be determined from the measured temperatures Tᵢ, namely coefficients B, C, D, and the core temperature T_{C}. As a consequence, at least four sensed temperatures Tᵢ, i=1 . . . 4, must be taken at the at least four different positions xᵢ, i=1 . . . 4. In this way, the system of four independent linear equations

(T_{C}−T_{A})×R₁=(Tᵢ−T_{A})×(Zᵢ+R₁) for i=1 . . . 4 (23)

can be employed for the determination of a unique solution of the four unknowns.

In similar fashion, embodiments of the method can be employed to determine core temperature T_{C} and the parameters of any polynomial relationship between total thermal resistance Zᵢ as a function of position xᵢ, where the polynomial is of order N. At least N+2 measurements of surface temperature Tᵢ must be made at the at least N+2 different positions xᵢ. This leads, again, to a system of N+2 independent linear equations, from which core temperature T_{C} and the N+1 parameters of the polynomial can be uniquely determined.

In some embodiments, the method can be employed for two-dimensional cases, where the total internal resistance Zᵢ is a polynomial in the two position variables xᵢ and yᵢ, where the pairs (xᵢ, yᵢ) are describing two-dimensional measurement positions.

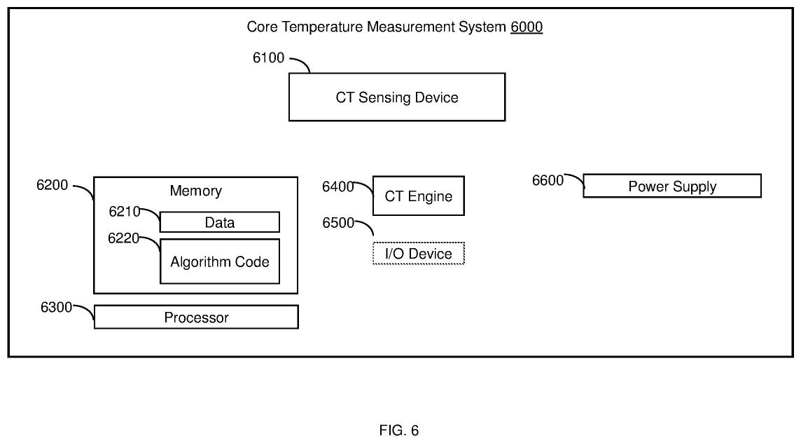

Additional reference is now made to FIG. 6. According to some embodiments, a CBT core temperature (CT) measurement system 6000 may comprise a CT sensing device 6100, configured for example as described herein with respect to CT sensing devices 1000 and 5000.

CT measurement system 6000 may be operable to receive and process signals from the sensor modules 1100 to produce an output representing core temperature T_{C}. The processing of the received signals may be performed in accordance with any one of the methods described herein.

Although certain components are herein shown as being separate from CT sensing device 6100, this should by no means be construed in a limiting manner. Accordingly, in some examples, certain components may be considered or be employed as part of a CT sensing device.

CT measurement system 6000 may include a memory 6200 configured to store data 6210 and algorithm code and/or machine learning code 6220, and a processor 6300. Memory may receive for example data that is descriptive of signals produced by CT sensing device, the signal pertaining to temperatures sensed by or at the surface thermometers and the ambient thermometers of the CT sensing device.

Processor 6300 may be configured to execute algorithm and/or machine learning code 6220 for the processing of data 6210 which may result in determining an object's core temperature, for example, according to any one or more of the methods described herein. The determining of an object's core temperature may herein also be referred to as implementing a CT engine 6400.

Generally, CT engine 6400 may implement various functionalities of CT measurement system 6000, e.g., as outlined herein.

For simplicity and without be construed in a limiting manner, the description and claims may refer to a single module and/or component. For example, although processor 6300 may be implemented by several processors, the following description will refer to processor 6300 as the component that conducts all the necessary processing functions of CT measurement system 6000.

Functionalities, processes, modules and/or components of CT measurement system 6000 may be implemented by one or more computing platforms. The one or more computing platforms may include a multifunction mobile communication device also known as “smartphone”, a personal computer, a laptop computer, a tablet computer, a server (which may relate to one or more servers or storage systems and/or services associated with a business or corporate entity, including for example, a file hosting service, cloud storage service, online file storage provider, peer-to-peer file storage or hosting service and/or a cyberlocker), personal digital assistant, a workstation, a wearable device, a handheld computer, a notebook computer, a vehicular device and/or a stationary device.

Memory 6200 may be implemented by various types of memories, including transactional memory and/or long-term storage memory facilities and may function as file storage, document storage, program storage, or as a working memory. The latter may for example be in the form of a static random-access memory (SRAM), dynamic random-access memory (DRAM), read-only memory (ROM), cache and/or flash memory. As working memory, memory 6200 may, for example, include, e.g., temporally-based and/or non-temporally based instructions. As long-term memory, memory 6200 may for example include a volatile or non-volatile computer storage medium, a hard disk drive, a solid state drive, a magnetic storage medium, a flash memory and/or other storage facility. A hardware memory facility may for example store a fixed information set (e.g., software code) including, but not limited to, a file, program, application, source code, object code, data, and/or the like.

The term “processor”, as used herein, may additionally or alternatively refer to a controller. Processor 6300 may be implemented by various types of processor devices and/or processor architectures including, for example, embedded processors, communication processors, graphics processing unit (GPU)-accelerated computing, soft-core processors and/or general purpose processors.

In some examples, for the implementing of CT engine 6400, memory 6200 may receive signals and/or data from an I/O device 6500.

As an input device, I/O device 6500 may include, for example, I/O device drivers, device interfaces (e.g., a Universal Serial Bus interface), or a wired and/or wireless communication module. The communication module may include network interface drivers (not shown) for enabling the transmission and/or reception of data over a network infrastructure. A device driver may for example, interface with a keypad or to a USB port. A network interface driver may for example execute protocols for the Internet, or an Intranet, Wide Area Network (WAN), Local Area Network (LAN) employing, e.g., Wireless Local Area Network (WLAN)), Metropolitan Area Network (MAN), Personal Area Network (PAN), extranet, 2G, 3G, 3.5G, 4G, 5G, 6G mobile networks, 3GPP, LTE, LTE advanced, Bluetooth® (e.g., Bluetooth smart), ZigBee™, near-field communication (NFC) and/or any other current or future communication network, standard, and/or system.

As an output device, I/O device 6500 may comprise, for example, a display device configured to display one or more images captured by a sensor and include, for example, head mounted display (HMD) device(s), first person view (FPV) display device(s), a monitor, a screen, a touch-screen, a flat panel display, a Light Emitting Diode (LED) display unit, a Liquid Crystal Display (LCD) display unit, a plasma display unit.

In some examples, I/O device 6500 may comprise one or more audio speakers or earphones, device interfaces (e.g., a Universal Serial Bus interface), and/or other suitable output devices.

In some embodiments, CT measurement system 6000 may include a power supply 6600 for powering the various components of the CT measurement system and/or the CT sensing device. Power supply 6600 may for example comprise an internal power supply (e.g., a rechargeable battery) and/or an interface for allowing connection to an external power supply.

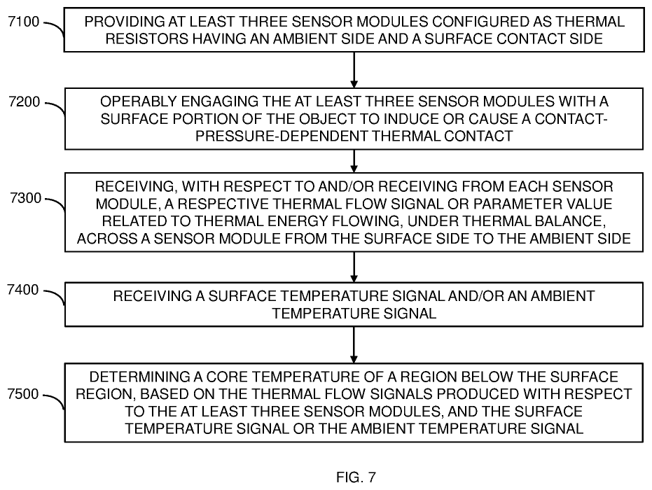

Reference is now made to FIG. 7. A method for determining a core temperature of a body may comprise:

Providing at least three sensor modules. Each sensor module may be configured as a thermal resistor and having a surface contact side and an ambient side (block 7100). The thermal resistance of the three sensor modules may be equal or substantially equal, and known.

Operably engaging the at least three sensor modules with a surface portion of the object to induce or cause a contact-pressure-dependent thermal contact (block 7200), between the object and the surface contact sides.

Sensing and/or receiving (e.g., by a thermal sensor) for each sensor module, a respective thermal flow signal or parameter value related to thermal energy flowing, under thermal balance, across a sensor module from the surface side to the ambient side (block 7300).

Sensing and/or receiving a surface temperature signal and/or an ambient temperature signal (block 7400). For example, at least one of the at least three sensor modules comprises a thermometer contact to sense a surface temperature for providing a surface temperature signal, and/or an ambient temperature for providing an ambient temperature signal.

Determining a core temperature of a region below the surface region, based on the thermal flow signals produced with respect to the at least three sensor modules, and the surface temperature signal and/or the ambient temperature signal (block 7500).

### ADDITIONAL EXAMPLES

Example 1 pertains to a core temperature sensing device for sensing the core temperature of an object, the device comprising: at least three sensor modules, each sensor module configured as a thermal resistor and having a surface contact side and an ambient side, wherein a sensor module comprises: a thermal sensor configured to produce a thermal flow signal related to thermal energy, under thermal balance, flowing across the sensor module from the surface side to the ambient side,

wherein at least one of the at least three sensor modules comprises a thermometer contact to sense a surface temperature of the object for providing a surface temperature signal, and/or an ambient temperature for providing an ambient temperature signal;
wherein the at least three sensor modules are rigidly coupled with each other to allow simultaneously operably engaging the surface contact sides with the surface of the object to cause surface deformation.

For instance, a same force may be applied onto the device to cause (e.g., elastic) deformation of the object, such that the surface contact sides each apply a different amount of force or pressure on the respective underlying surface contact region engaged by the surface contact sides. Hence, the force distribution applied by the surface contact sides may be non-equal and may for instance be expressed by a corresponding mathematical model. The non-equal pressure applied onto the surface may result in a non-equal thermal contact resistance between the object's surface and each one of the surface contact sides.

Example 2 includes the subject matter of Example 1 and, optionally, wherein the at least three surface contact sides are coplanar or not coplanar.

Example 3 includes the subject matter of examples 1 and/or 2 and, optionally, wherein the at least three ambient contact sides are coplanar or not coplanar.

Example 4 includes the subject matter of any one or more of the examples 1 to 3 and, optionally, wherein the at least three sensor modules have an identical or substantially identical (known) thermal resistance, or wherein the at least three sensor modules each have different (known) thermal resistance compared to each other.

Example 5 includes the subject matter of any one or more of the examples 1 to 4 and, optionally, wherein each sensor module comprises a surface thermometer contact and an ambient thermometer contact.

Example 6 includes the subject matter of any one or more of the examples 1 to 5 and, optionally, wherein each sensor module comprises a surface thermometer contact and a thermal flux sensor.

Example 7 includes the subject matter of any one or more of the examples 1 to 6 and, optionally, wherein a same ambient thermometer contact is thermally coupled with at least two of the at least three sensor modules.

Example 8 includes the subject matter of any one or more of the examples 1 to 7 and, optionally, wherein each sensor module comprises a thermal flux sensor and a same ambient thermometer contact that is thermally coupled with at least two of the at least three sensor modules.

Example 9 pertains to a core temperature measurement system, comprising a core temperature sensing device for instance, according to any one or more of the examples 1 to 8 and, optionally, a memory storing software code instructions; and a processor configured to execute software instructions stored in the memory to perform the following, based on the thermal flow signals produced with respect to the at least three sensor modules, and the surface temperature signal or the ambient temperature signal, when at least three sensor modules are operably engaged with a surface portion of an object to induce a contact-pressure-dependent thermal contact: determining a core temperature of a region below the surface region.

Example 10 includes the subject matter of example 9 and, optionally, wherein the determining of the core temperature is based on a linear or non-linear mathematical model describing the thermal contact resistance values between the surface thermometer contact of each sensor module, and the object surface region.

Example 11 includes the subject matter of any one or more of the examples 9 or 10 and, optionally, wherein the determining of the core temperature is based on a heat-balance across each one of the sensor modules.

Example 12 includes the subject matter of any one or more of the examples 9 to 11 and, optionally, wherein the mathematical model is stored in the memory and constructed to represent a set of equations with equal known and unknown temperature sensing parameter values and that are solvable for the core temperature value T_{C}.

Example 13 includes the subject matter of examples 9 to 11 and, optionally, wherein the mathematical model is stored in the memory and constructed to represent a set of overdetermined equations, such that the core temperature value T_{C} can be determined using an optimization process.

Example 14 pertains to a method for determining a core temperature, the method comprising providing at least three sensor modules, each sensor module configured as a thermal resistor and having a surface contact side and an ambient side, wherein a sensor module comprises: a thermal sensor configured to produce a thermal flow signal related to thermal energy, under thermal balance, flowing across the sensor module from the surface side to the ambient side, wherein at least one of the at least three sensor modules comprises a thermometer contact to sense a surface temperature for providing a surface temperature signal, or an ambient temperature for providing an ambient temperature signal; determining a core temperature of a region below the surface region, based on the thermal flow signals produced with respect to the at least three sensor modules, and the surface temperature signal or the ambient temperature signal, when at least three sensor modules are operably engaged with a surface portion of an object to induce a contact-pressure-dependent thermal contact.

Example 15 includes the subject matter of example 14 and, optionally, the determining of the core temperature is based on a linear or non-linear mathematical model describing the thermal contact resistance values between the surface thermometer contact of each sensor module, and the object surface region.

Example 16 includes the subject matter of examples 14 or 15 and, optionally, wherein the determining of the core temperature is based on a heat-balance across each one of the sensor modules.

Example 17 includes the subject matter of any one or more of examples 14 to 16 and, optionally, wherein a sensor module or each sensor comprises a surface thermometer contact and an ambient thermometer contact.

Example 18 includes the subject matter of any one or more of the examples 14 to 17 and, optionally, wherein a sensor module or each sensor module comprises a surface thermometer contact and a thermal flux sensor.

Example 19 includes the subject matter of any one or more of the examples 14 to 18 and, optionally, wherein a same ambient thermometer contact is thermally coupled with at least two of the at least three sensor modules.

Example 20 includes the subject matter of any one or more of the examples 14 to 19 and, optionally, wherein a sensor module or each sensor module comprises a thermal flux sensor and a same ambient thermometer contact that is thermally coupled with at least two of the at least three sensor modules.

Example 21 includes the subject matter of any one or more of the examples 14 to 20 and, optionally, storing the mathematical model in a memory, wherein the mathematical model is constructed to represent a set of equations with equal known and unknown temperature sensing parameter values and that are solvable for the core temperature value T_{C}.

Example 22 includes the subject matter of any one or more of the examples 14 to 20 and, optionally, storing the mathematical model in a memory, wherein the mathematical model is constructed to represent a set of overdetermined equations, such that the core temperature value T_{C} can be determined using an optimization process.

Example 23 pertains to a sensing device employable for determining core temperature, comprising: at least three sensor modules, each sensor module configured as a thermal resistor, wherein a sensor module comprises: a surface thermometer contact configured to produce a surface temperature signal relating to a sensed surface temperature; and an ambient thermometer contact configured to produce an ambient temperature signal relating to a sensed ambient temperature; wherein the surface thermometer contact and the ambient thermometer contact are thermally connected to opposite ends of the thermal resistor; wherein the at least three sensor modules are rigidly coupled with each other to allow simultaneously engaging the surface contact sides with the surface of the object and to apply a force to cause deformation of the surface. For instance, a same force applied onto the device may cause elastic deformation of the object. The surface contact sides may each apply a different amount of force or pressure on the respective underlying surface contact region engaged by the surface contact sides. Hence, the force distribution applied by the surface contact sides may be non-equal and may for instance be expressed by a corresponding mathematical model. The non-equal pressure applied onto the object's surface results in a non-equal thermal contact resistance between the surface and the surface contact sides.

Example 24 includes the subject matter of examples 23 and/or 24 and, optionally, wherein the at least three ambient thermometer contacts are coplanar or not coplanar.

Example 25 includes the subject matter of any one or more of the examples 23 to 25 and, optionally, wherein the at least three sensor modules have an identical or substantially identical (known) thermal resistance, or wherein the at least three sensor modules have (known) different thermal resistance, compared to each other.

Example 26 includes a core temperature measurement system comprising: a core temperature sensing device, for instance, any one or more of the examples 23 to 26; a memory storing software code instructions; and a processor configured to execute software instructions stored in the memory to perform the following, when the at least three sensor modules are operably engaged with a surface portion of an object to cause elastic deformation of the surface region: determining a core temperature of a region below the surface region, optionally, based on determining a flux of thermal energy flowing across the at least three sensor modules.

Example 27 pertains to a device used for determining core temperature, comprising: at least three sensor modules, each sensor module configured as a thermal resistor, wherein a sensor module comprises: a surface thermometer contact configured to produce a surface temperature signal relating to a sensed surface temperature; and an ambient thermometer contact configured to produce an ambient temperature signal relating to a sensed ambient temperature; wherein the surface thermometer contact and the ambient thermometer contact are thermally insulated from each other, a memory storing software code instructions; and a processor configured to execute software instructions stored in the memory to perform the following, when the at least three sensor modules are operably engaged with a surface portion of an object to cause elastic deformation of the surface region: determining a flux of thermal energy flowing across the at least three sensor modules.

Example 28 pertains to a device or a method for the simultaneous measurement of the core temperature of an object and the surface contact thermal resistance, consisting of at least three sensor modules in a rectilinear geometric arrangement or four sensor modules in two-dimensional geometric arrangement characterized in that the sensor modules are capable of measuring the thermal balance across a thermal resistor of known thermal resistance value; all sensor modules are mounted on a mechanically rigid substrate; the device is pressed against the object with a force that stays in the elastic deformation range of the object for each sensor module, such that a linear model of the thermal contact resistance values of the sensor modules can be constructed; a set of equations can be generated which can be solved for the unknown parameters, in particular the sought core temperature of the object and the individual surface contact thermal resistances to each of the sensor modules, making use of the measured values of the sensor modules.

It is important to note that the methods described herein and illustrated in the accompanying diagrams shall not be construed in a limiting manner. For example, methods described herein may include additional or even fewer processes or operations in comparison to what is described herein and/or illustrated in the diagrams. In addition, method steps are not necessarily limited to the chronological order as illustrated and described herein.

Any digital computer system, unit, device, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may directly loadable into an internal memory of a digital computer, comprising software code portions for performing the methods and/or processes as disclosed herein.

The methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The term “engine” may comprise one or more computer modules, wherein a module may be a self-contained hardware and/or software component that interfaces with a larger system. A module may comprise a machine or machines executable instructions. A module may be embodied by a circuit or a controller programmed to cause the system to implement the method, process and/or operation as disclosed herein. For example, a module may be implemented as a hardware circuit comprising, e.g., custom VLSI circuits or gate arrays, an application-specific integrated circuit (ASIC), off-the-shelf semiconductors such as logic chips, transistors, and/or other discrete components. A module may also be implemented in programmable hardware devices such as field programmable gate arrays, programmable array logic, programmable logic devices and/or the like.

The term “random” also encompasses the meaning of the term “substantially randomly” or “pseudo-randomly”.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms “substantially”, “′about” and/or “close” with respect to a magnitude or a numerical value may imply to be within an inclusive range of −10% to +10% of the respective magnitude or value.

“Coupled with” can mean indirectly or directly “coupled with”.

Discussions herein utilizing terms such as, for example, “processing”, “computing”, “calculating”, “determining”, “establishing”, “analyzing”, “checking”, “estimating”, “deriving”, “selecting”, “inferring” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The term determining may, where applicable, also refer to “heuristically determining”.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not be construed as excluding an embodiment referring to a condition “equal or below a threshold”. It is clear that, should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

Terms used in the singular shall also include the plural, except where expressly otherwise stated or where the context otherwise requires.

In the description and claims of the present application, each of the verbs, “comprise” “include” and “have”, and conjugates thereof, are used to indicate that the data portion or data portions of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made. Further, the use of the expression “and/or” may be used interchangeably with the expressions “at least one of the following”, “any one of the following” or “one or more of the following”, followed by a listing of the various options.

As used herein, the phrase “A, B, C, or any combination of the aforesaid” should be interpreted as meaning all of the following: (i) A or B or C or any combination of A, B, and C, (ii) at least one of A, B, and C; (iii) A, and/or B and/or C, and (iv) A, B and/or C. Where appropriate, the phrase A, B and/or C can be interpreted as meaning A, B or C. The phrase A, B or C should be interpreted as meaning “selected from the group consisting of A, B and C”. This concept is illustrated for three elements (i.e., A,B,C), but extends to fewer and greater numbers of elements (e.g., A, B, C, D, etc.).

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example, or option of the invention. Certain features described in the context of various embodiments, examples and/or optional implementation are not to be considered essential features of those embodiments, unless the embodiment, example and/or optional implementation is inoperative without those elements.

It is noted that the terms “in some embodiments”, “according to some embodiments”, “for example”, “e.g.”, “for instance” and “optionally” may herein be used interchangeably.

The number of elements shown in the Figures should by no means be construed as limiting and is for illustrative purposes only.

Positional terms such as “upper”, “lower” “right”, “left”, “bottom”, “below”, “lowered”, “low”, “top”, “above”, “elevated”, “high”, “vertical” and “horizontal” as well as grammatical variations thereof as may be used herein do not necessarily indicate that, for example, a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

It is noted that the terms “operable to” can encompass the meaning of the term “modified or configured to”. In other words, a machine “operable to” perform a task can in some embodiments, embrace a mere capability (e.g., “modified”) to perform the function and, in some other embodiments, a machine that is actually made (e.g., “configured”) to perform the function.

Throughout this application, various embodiments may be presented in and/or relate to a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

While the invention has been described with respect to a limited number of embodiments, these should not be construed as limitations on the scope of the invention, but rather as exemplifications of some of the embodiments.

What is claimed is:

1. A core temperature sensing device for sensing the core temperature of an object, the device comprising:
at least three sensor modules, each sensor module configured as a thermal resistor and having a surface contact side and an ambient side, wherein a sensor module comprises:
a thermal sensor configured to produce a thermal flow signal related to thermal energy, under thermal balance, flowing across the sensor module from the surface side to the ambient side,
wherein at least one of the at least three sensor modules comprises a thermometer contact to sense a surface temperature of the object for providing a surface temperature signal, and/or an ambient temperature for providing an ambient temperature signal; and
wherein the at least three sensor modules are rigidly coupled with each other to allow simultaneously operably engaging the surface contact sides with the surface of the object to cause surface deformation.

2. The core temperature sensing device of claim 1, wherein the at least three surface contact sides are coplanar or not coplanar.

3. The core temperature sensing device of claim 1, wherein the at least three ambient contact sides are coplanar or not coplanar.

4. The core temperature sensing device of claim 1, wherein the at least three sensor modules each have different thermal resistance.

5. The core temperature sensing device of claim 1, wherein each sensor module comprises a surface thermometer contact and an ambient thermometer contact.

6. The core temperature sensing device of claim 1, wherein each sensor module comprises a surface thermometer contact and a thermal flux sensor.

7. The core temperature sensing device of claim 1, wherein a same ambient thermometer contact is thermally coupled with at least two of the at least three sensor modules.

8. The core temperature sensing device of claim 1, wherein each sensor module comprises a thermal flux sensor and a same ambient thermometer contact that is thermally coupled with at least two of the at least three sensor modules.

9. A core temperature measurement system, comprising
a core temperature sensing device according to any one or more of the preceding claims;
a memory storing software code instructions; and
a processor configured to execute software instructions stored in the memory to perform the following, based on the thermal flow signals produced with respect to the at least three sensor modules, and the surface temperature signal or the ambient temperature signal, when at least three sensor modules are operably engaged with a surface portion of an object to induce a contact-pressure-dependent thermal contact:
determining a core temperature of a region below the surface region.

10. The core temperature measurement system of claim 9, wherein the determining of the core temperature is based on a linear or non-linear mathematical model describing the thermal contact resistance values between the surface thermometer contact of each sensor module, and the object surface region.

11. The core temperature measurement system of claim 9, wherein the determining of the core temperature is based on a heat-balance across each one of the sensor modules.

12. The core temperature measurement system of claim 9, wherein the mathematical model is stored in the memory and constructed to represent a set of equations with equal known and unknown temperature sensing parameter values and that are solvable for the core temperature value T_{C}.

13. The core temperature measurement system of claim 9, wherein the mathematical model is stored in the memory and constructed to represent a set of overdetermined equations, such that the core temperature value T_{C} can be determined using an optimization process.

14. A method for determining a core temperature, comprising:
providing at least three sensor modules, each sensor module configured as a thermal resistor and having a surface contact side and an ambient side, wherein a sensor module comprises:
a thermal sensor configured to produce a thermal flow signal related to thermal energy, under thermal balance, flowing across the sensor module from the surface side to the ambient side,
wherein at least one of the at least three sensor modules comprises a thermometer contact to sense a surface temperature for providing a surface temperature signal, or an ambient temperature for providing an ambient temperature signal; and
determining a core temperature of a region below the surface region, based on the thermal flow signals produced with respect to the at least three sensor modules, and the surface temperature signal or the ambient temperature signal, when at least three sensor modules are operably engaged with a surface portion of an object to induce a contact-pressure-dependent thermal contact.

15. The method of claim 14, wherein the determining of the core temperature is based on a linear or non-linear mathematical model describing the thermal contact resistance values between the surface thermometer contact of each sensor module, and the object surface region.

16. The method of claim 14, wherein the determining of the core temperature is based on a heat-balance across each one of the sensor modules.

17. The method of claim 14, wherein each sensor module comprises a surface thermometer contact and an ambient thermometer contact.

18. The method of claim 14, wherein each sensor module comprises a surface thermometer contact and a thermal flux sensor.

19. The method of claim 14, wherein a same ambient thermometer contact is thermally coupled with at least two of the at least three sensor modules.

20. The method of claim 14, wherein each sensor module comprises a thermal flux sensor and a same ambient thermometer contact that is thermally coupled with at least two of the at least three sensor modules.

21. (canceled)

22. (canceled)

23. (canceled)

24. (canceled)

25. (canceled)

26. (canceled)

27. (canceled)

28. (canceled)
